(19) United States
(12) Patent Application Publication
(10) Pub. No.: US 2026/0313056 A1
(43) Pub. Date: Oct. 8, 2026

(54) IMAGE READING APPARATUS AND CONTROL METHOD OF IMAGE READING APPARATUS

(71) Applicant: SEIKO EPSON CORPORATION, Tokyo (JP)

(72) Inventors: Hiroki IMAI, Shiojiri (JP); Shoji YAMAMOTO, Matsumoto (JP)

(21) Appl. No.: 19/461,957

(22) Filed: Jan. 28, 2026

(30) Foreign Application Priority Data
Jan. 30, 2025 (JP) 2025-013731

(51) Int. Cl. H04N 1/024; H04N 1/047; H04N 1/10

(52) U.S. Cl. CPC H04N 1/02409; H04N 1/047; H04N 1/1013; H04N 2201/04703; H04N 2201/04713; H04N 2201/04717

(57) ABSTRACT

An image reading apparatus includes: a carriage on which a CIS type sensor is mounted; a first scanning unit configured to move the carriage in a first direction; a second scanning unit configured to move the carriage in a second direction perpendicular to the first direction; and a support unit configured to support a medium at a position facing the sensor.

The present application is based on, and claims priority from JP Application Serial Number 2025-013731, filed Jan. 30, 2025, the disclosure of which is hereby incorporated by reference herein in its entirety.

### BACKGROUND

### 1. Technical Field

The present disclosure relates to an image reading apparatus and a control method of the image reading apparatus.

### 2. Related Art

In the related art, as disclosed in JP-A-2005- 45433, it is known that a lens is moved to adjust a focal point in an apparatus including a charge coupled device (CCD) type sensor.

In a contact image sensor (CIS) type sensor, a focal length is shorter than that of the CCD type sensor, and it is difficult to focus the sensor.

### SUMMARY

An image reading apparatus includes: a carriage on which a CIS type sensor is mounted; a first scanning unit configured to move the carriage in a first direction; a second scanning unit configured to move the carriage in a second direction perpendicular to the first direction; and a support unit configured to support a medium at a position facing the sensor.

An image reading apparatus includes: a carriage on which a CIS type sensor is mounted; a first scanning unit configured to move the carriage along a first scanning shaft in a first direction; a third scanning unit configured to move the first scanning shaft along a third scanning shaft in a second direction perpendicular to the first direction; and a support unit configured to support a medium at a position facing the sensor.

Provided is a control method of an image reading apparatus including a carriage on which a CIS type sensor is mounted, a first scanning unit configured to move the carriage in a first direction, a second scanning unit configured to move the carriage in a second direction perpendicular to the first direction, and a support unit configured to support a medium at a position facing the sensor, the control method including: causing the second scanning unit to move the carriage in the second direction by a predetermined distance; calculating a focusing evaluation value by causing the sensor to read the medium while causing the first scanning unit to move the carriage in the first direction; calculating a focusing value that is a maximum value of the focusing evaluation value to specify a focusing position in the second direction corresponding to the focusing value, and causing the second scanning unit to move the carriage to the focusing position in the second direction.

### BRIEF DESCRIPTION OF THE DRAWINGS

FIG. 1 is a cross-sectional view illustrating a main part of an image reading apparatus including a first scanning unit and a second scanning unit that move a carriage on which a sensor unit is mounted.

FIG. 2 is a flowchart illustrating a control method of the image reading apparatus.

FIG. 3 is a graph illustrating a relationship between a height of the carriage and a focusing evaluation value.

FIG. 4 is a schematic diagram illustrating a distance sensor mounted on the sensor unit.

FIG. 5 is a cross-sectional view of the image reading apparatus illustrating a position and a focusing evaluation value when reading is performed by the sensor unit in a first region and a second region on the left and right of a document.

FIG. 6 is a cross-sectional view illustrating a main part of an image reading apparatus according to another example including a first scanning unit and a third scanning unit that move a carriage.

FIG. 7 is a cross-sectional view illustrating an image reading apparatus that reads a chart supported by a chart support tool.

FIG. 8 is a schematic diagram illustrating the chart of FIG. 7.

### DESCRIPTION OF EMBODIMENTS

Embodiments will be described with reference to the drawings. It should be noted that directions in the drawings will be described by using a three-dimensional coordinate system. For convenience of description, a positive direction of a Z-axis will be referred to as an upward direction or simply upward, a negative direction of the Z-axis will be referred to as a downward direction or simply downward, a positive direction of an X-axis will be referred to as a right direction or simply right, a negative direction of the X-axis will be referred to as a left direction or simply left, a positive direction of a Y-axis will be referred to as a forward direction or simply forward, and a negative direction of the Y-axis will be referred to as a rearward direction or simply rearward.

### 1. Image Reading Apparatus

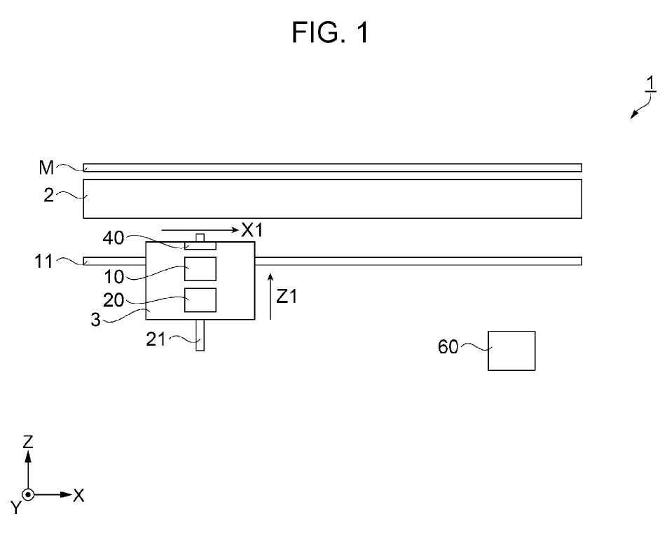

As illustrated in FIG. 1, an image reading apparatus 1 according to an example of the embodiment includes a document table 2 as a support unit that can support a document M as a medium, a CIS type sensor unit 40, and a carriage 3 on which the sensor unit 40 is mounted.

Hereinafter, the sensor unit 40 will be simply referred to as a sensor 40. The sensor 40 can read an image of the document M from below through the document table 2.

The document table 2 can support the document M at a position facing the sensor 40. The document table 2 is formed of glass or the like through which detection light of the sensor 40 can transmit.

The image reading apparatus 1 includes a first scanning unit 10 that can move the carriage 3 to the left and right along a first guide rail 11 that is a first scanning shaft, and a second scanning unit 20 that can move the carriage b in the up-down direction along a second guide rail 21 that is a second scanning shaft. The first scanning unit 10 and the second scanning unit 20 will be collectively referred to as the scanning unit.

The carriage 3 is freely movable in directions perpendicular to each other by the rail type scanning units including the first guide rail 11 and the second guide rail 21. The movement of the carriage 3 will also be referred to as scanning.

The first scanning unit 10 includes a first motor (not illustrated) that can move the carriage 3, and the second scanning unit 20 includes a second motor (not illustrated) that can move the carriage 3.

The image reading apparatus 1 includes a control unit 60. The control unit 60 includes a central processing unit (CPU) that integrally controls each of the units of the image reading apparatus 1 and a memory that stores a program such as firmware. The CPU will also be referred to as a processor. The CPU of the control unit 60 reads and executes the program of the memory.

### 2. Control Method of Image Reading Apparatus

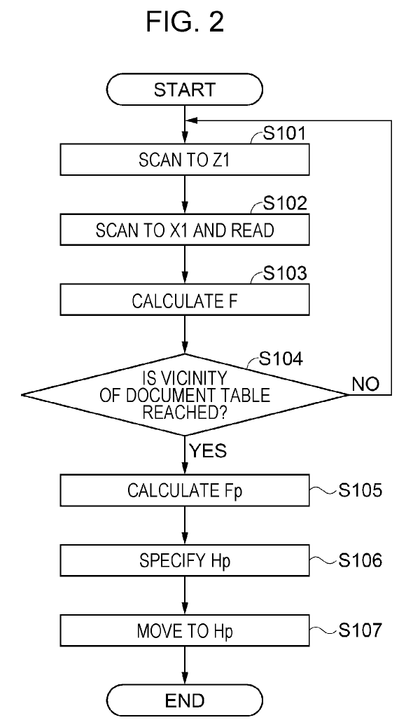

A control method of the image reading apparatus 1 will be described with reference to FIG. 2. The control unit 60 of the image reading apparatus 1 starts the process, and causes the second scanning unit 20 to move the carriage 3 to lift the carriage 3 by a predetermined distance in a second direction Z1 that is a position specifying direction and is the upward direction (S101). It is assumed that the sensor 40 is previously positioned to be sufficiently separated downward from the document table 2.

Next, the control unit 60 causes the sensor 40 to read the document M while causing the first scanning unit 10 to move the carriage 3 in a first direction X1 that is a reading direction (S102). The first direction X1 and the second direction Z1 are two directions perpendicular to each other.

Hereinafter, the operation of the movement by the second scanning unit 20 and the first scanning unit 10 and the reading by the sensor 40 will be referred to as a position specifying operation. The position specifying operation is an operation for specifying a focusing position Hp described below.

The control unit 60 calculates a focusing evaluation value F based on a pixel value read by the sensor 40 (S103).

The control unit 60 determines whether or not the sensor 40 mounted on the carriage 3 reaches the vicinity of the document table 2 (S104). When the control unit 60 determines that the sensor 40 does not reach the vicinity of the document table 2 (S104: NO), the position specifying operation and the calculation of the focusing evaluation value F are repeatedly executed.

The vicinity of the document table 2 refers to a position immediately before the carriage 3 and the sensor 40 come into contact with the document table 2.

On the other hand, when the control unit 60 determines that the sensor 40 reaches the vicinity of the document table 2 (S104: YES), the control unit 60 calculates a focusing value Fp that is a maximum value of the focusing evaluation value F (S105), and specifies the focusing position Hp that is a position in the second direction Z1 corresponding to the focusing value Fp (S106).

The control unit 60 causes the second scanning unit 20 to move the carriage 3 to the focusing position Hp (S107), and ends the process.

The sensor 40 may be previously positioned in an upper region in the vicinity of the document table 2. In this case, the control unit 60 may cause the second scanning unit 20 to move the carriage 3 to lower the carriage 3 by a predetermined distance in the downward direction that is a direction opposite to the second direction Z1. In addition, the reading direction by the first scanning unit 10 may be a direction opposite to the first direction X1.

That is, the second direction Z1 may be any direction in the up-down direction, and the first direction X1 may be any direction in the left-right direction.

The control unit 60 reads the image of the document M through the above-described position specifying operation, and calculates the focusing evaluation value F using a focusing method. The focusing method is a measurement method of searching for an optical in-focus position while moving the document M that is a reading object between the sensors 40 at intervals of a predetermined distance, and will also be referred to as a focus variation method.

Specifically, the control unit 60 calculates the focusing evaluation value F by executing high-pass filtration on the pixel values of the image of the document M that is read by the sensor 40 moved by the predetermined distance, extracting a high frequency component, and executing a predetermined arithmetic operation.

As the high frequency component extracted by the control unit 60 increases, the contrast increases, and a high contrast represents a high degree of focusing. Accordingly, as the value of the focusing evaluation value F increases, the degree of focusing increases.

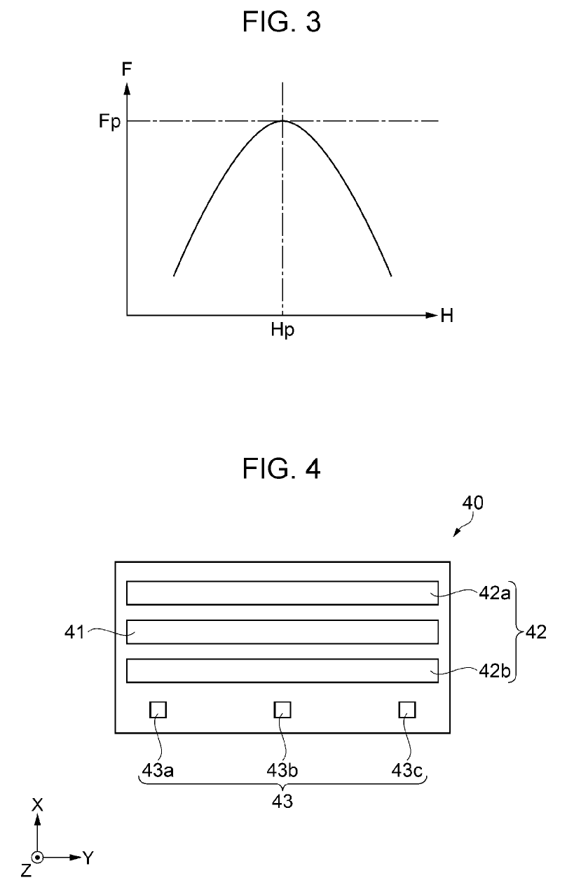

The focusing value Fp and the focusing position Hp will be described in detail with reference to FIG. 3.

In FIG. 3, the horizontal axis represents a height H that is a position of the sensor 40 when the second scanning unit 20 moves the carriage 3 in the second direction Z1 in the position specifying operation. In FIG. 3, the vertical axis represents the result of causing the control unit 60 to calculate the focusing evaluation value F by causing the sensor 40 to read the image of the document M while causing the first scanning unit 10 to move the carriage 3 in the first direction X1 in the position specifying operation.

When the sensor 40 reads the document M at a plurality of positions in the first direction X1, the control unit 60 can calculate the focusing evaluation value F, for example, based on any of an average value, a median value, a mode value, a deviation value, and the like of the read plurality of pixel values.

Alternatively, the control unit 60 may calculate the focusing evaluation value F for each of the read pixel values at the plurality of positions to calculate the final focusing evaluation value F based on any of an average value, a median value, a mode value, a deviation value, and the like of the pixel values of the focusing evaluation values F.

As described in the description of FIG. 1, it is assumed that the sensor 40 is previously positioned to be sufficiently separated downward from the document table 2, and this position is a reference position. The control unit 60 controls the second motor of the second scanning unit 20 to calculate the height H that is the distance from the reference position and is the position of the sensor 40 in the second direction Z1.

The control unit 60 can control the second scanning unit 20 to move the carriage 3 by the predetermined distance in the second direction Z1 while calculating the height H. In addition, the control unit 60 can specify the focusing position Hp based on the calculated height H.

As illustrated in FIG. 3, when the focusing evaluation value F is the focusing value Fp as the maximum value, the position of the sensor 40 in the second direction Z1 is the focusing position Hp. That is, the focusing position Hp is the position where the sensor 40 is optically most focused on the document M.

The control unit 60 can calculate the focusing value Fp where the focusing evaluation value F is the maximum value to specify the focusing position Hp corresponding to the focusing value Fp.

By causing the second scanning unit 20 to move the sensor 40 to the focusing position Hp, the image reading apparatus 1 can read the document M at the position where the sensor 40 is focused while causing the first scanning unit 10 to move the carriage 3 in the first direction X1.

It is difficult to focus the CIS type sensor 40 because the focal length is shorter than the CCD type sensor. The height H illustrated in FIG. 3 is a value relating to the focal length. The image reading apparatus 1 can easily specify the focusing position Hp corresponding to the focal length to be accurately focused using the first scanning unit 10 and the second scanning unit 20.

The image reading apparatus 1 can execute reading at the focusing position Hp where the sensor 40 is focused on the document M to acquire a high-quality image.

As described above, the control unit 60 calculates the height H of the sensor 40 based on the control of the second scanning unit 20 for the second motor.

As illustrated in FIG. 4, a distance sensor 43 may be mounted on the sensor 40 to detect a distance between the sensor 40 and the document M through the document table 2 such that the control unit 60 calculates the height H. The distance sensor 43 may detect a distance between the sensor 40 and the document table 2 such that the control unit 60 calculates the height H. The sensor 40 detects a distance to the document M or the document table 2.

The control unit 60 can calculate the height H that is the position of the sensor 40 in the second direction Z1 based on the detection value of the distance sensor 43.

The distance sensor 43 is, for example, an infrared sensor or an ultrasonic sensor.

At a left end that is one end of the sensor 40, at least any of a first distance sensor 43a, a second distance sensor 43b, and a third distance sensor 43c is disposed as the distance sensor 43 in the front-rear direction.

When the sensor 40 is focused on the center of the document M, it is preferable that the second distance sensor 43b is disposed at the center. When the sensor 40 is focused on an end of the document M, for example, when the document M is positioned and supported on the document table 2, it is preferable that the first distance sensor 43a is disposed at a rear end or the third distance sensor 43c is disposed at a front end.

The sensor 40 includes: a sensor array 41 that is composed of a plurality of photo sensors arranged in the front-rear direction; and a first light source 42a and a second light source 42b as a light source 42 such as a plurality of LEDs arranged in the front-rear direction on the left and right of the sensor array 41. The first light source 42a and the second light source 42b reflect light emitted from the left and right to the image of the document M such that the sensor array 41 at the center can read the light as a pixel value.

The distance sensor 43, the sensor array 41, and the light source 42 in the sensor 40 are disposed to face the document table 2 from below.

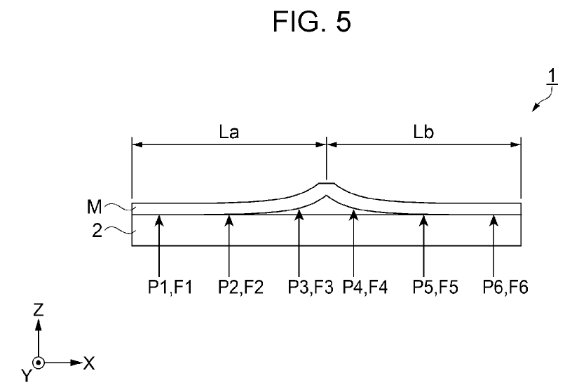

Incidentally, as illustrated in FIG. 5, the document M supported by the document table 2 may be bilaterally symmetrical as in double-page spread. In FIG. 5, in order to easily understand the drawing, the sensor 40, the first scanning unit 10, the second scanning unit 20, and the like are not illustrated, but the image reading apparatus 1 has the same configuration as that of FIG. 1.

For example, in the first position specifying operation, as described above, the control unit 60 calculates the focusing evaluation value F at each of a plurality of positions of the document M by causing the sensor 40 to read the document M at each of the positions while causing the first scanning unit 10 to move the carriage 3 in the first direction X1.

Specifically, as illustrated in FIG. 5, the sensor 40 reads the document M at a first position P1, a second position P2, and a third position P3 in a first region La on the left side that is one side of the document M in the right direction as the first direction X1, and reads the document M at a fourth position P4, a fifth position P5, and a sixth position P6 in a second region Lb on the right side that is the other side of the document M. The first position P1 to the third position P3 are bilaterally symmetric positions of the document M corresponding to the sixth position P6 to the fourth position P4 in this order.

At the first position P1 to the third position P3 and the sixth position P6 to the fourth position P4 that are the plurality of bilaterally symmetric positions of the document M, the control unit 60 calculates a first focusing evaluation value F1 to a third focusing evaluation value F3 and a sixth focusing evaluation value F6 to a fourth focusing evaluation value F4, respectively, as the focusing evaluation values F.

When the control unit 60 determines that the first focusing evaluation value F1 and the sixth focusing evaluation value F6, the second focusing evaluation value F2 and the fifth focusing evaluation value F5, and the third focusing evaluation value F3 and the fourth focusing evaluation value F4 are close to each other, respectively, the control unit 60 can estimate that the document M is bilaterally symmetrical.

For example, the control unit 60 can estimate that the document M has a bilaterally symmetrical shape as in double-page spread.

In the second or subsequent position specifying operation, the control unit 60 can cause the sensor 40 to move to one of the first region La and the second region Lb for reading and to skip reading without moving to the other region of the first region La and the second region Lb. The control unit 60 can apply the focusing evaluation value F calculated in the one region as the focusing evaluation value F of the other region. The control unit 60 can reduce the time of the position specifying operation and the calculation of the focusing evaluation value F.

FIG. 5 illustrates the example where the document M is double-page spread. However, the document M may have a bilaterally symmetrical sheet shape.

This way, the control unit 60 causes the sensor 40 to read the first region La on the one side of the document M and the second region Lb on the other side of the document M in the first direction X1 at symmetric positions. The control unit 60 calculates the focusing evaluation value F based on pixel values read at the symmetric positions.

When it is determined that the calculated focusing evaluation values F are close to each other at the symmetric positions, the control unit 60 causes the sensor 40 to read one of the first region La and the second region Lb and to skip reading the other region of the first region La and the second region Lb.

### 3. Image Reading Apparatuses of Other Examples

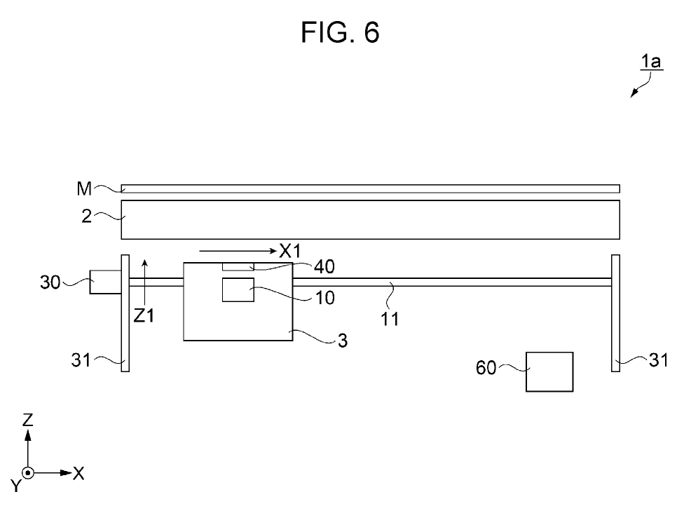

As illustrated in FIG. 6, an image reading apparatus 1a according to another example of the embodiment includes a third scanning unit 30 instead of the second scanning unit 20 of the image reading apparatus 1 illustrated in FIG. 1, and the other configurations thereof are the same as those of the image reading apparatus 1. The third scanning unit 30 can move the first guide rail 11 on which the carriage 3 is mounted in the second direction Z1 along a third guide rail 31 that is a third scanning shaft. That is, the third scanning unit 30 can move the carriage 3 in the second direction Z1.

The third scanning unit 30 includes a third motor (not illustrated) that can move the first guide rail 11. The third guide rail 31 is disposed on the left and right of the image reading apparatus 1a and can stably move the first guide rail 11.

The image reading apparatus 1a can cause the third scanning unit 30 to move the carriage 3 and the sensor 40 mounted on the carriage 3 in the second direction Z1 instead of the second scanning unit 20 of the image reading apparatus 1.

The image reading apparatus 1a can execute the same operation as the above-described position specifying operation. The image reading apparatus 1a can lift the carriage 3 by a predetermined distance by causing the third scanning unit 30 to move the third guide rail 31 in the second direction Z1 that is the position specifying direction and is the upward direction.

Next, in the position specifying operation, as in the above-described image reading apparatus 1, the image reading apparatus 1a can cause the sensor 40 to read the document M while causing the first scanning unit 10 to move the carriage 3 in the first direction X1 that is the reading direction.

The image reading apparatus 1a can execute the same control method using the third scanning unit 30 as the control method of the image reading apparatus 1 described above with reference to FIG. 2. The image reading apparatus 1a can execute the other operations as in the above-described image reading apparatus 1.

### 4. Chart

In the document M having a low contrast, there is a concern that the control unit 60 cannot accurately calculate the focusing evaluation value F.

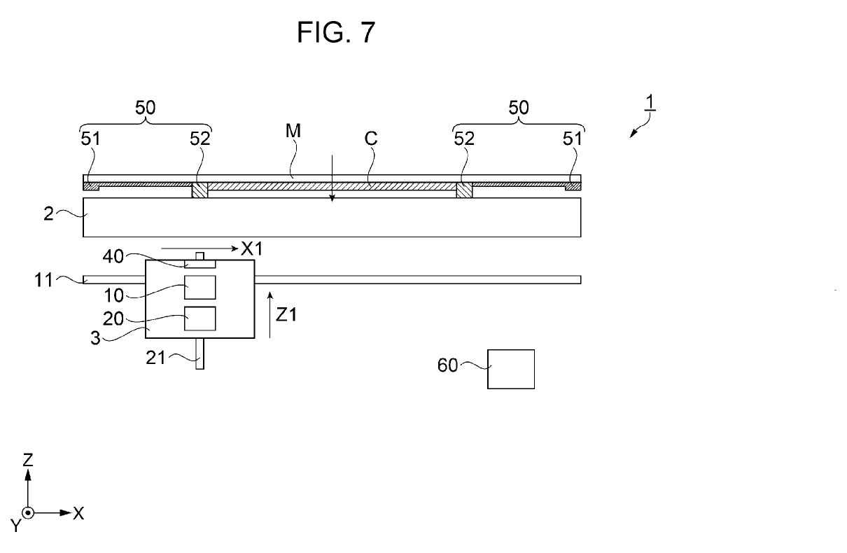

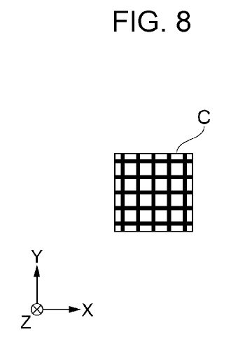

Accordingly, as illustrated in FIG. 7, the image reading apparatus 1 causes the sensor 40 to read a chart C having a high contrast illustrated in FIG. 8 disposed to overlap the document M as described above with reference to FIGS. 1 to 5.

The rectangular chart C is supported by a chart support tool 50 and is disposed to overlap the document M. The chart C is at a position facing the sensor 40 through the document table 2. The sensor 40 can read an image of the chart C disposed to overlap the document M from below through the document table 2. The chart support tool 50 includes a rectangular frame 51 that surrounds the chart C and an elastic member 52 that is attached to the frame 51. The inside of the frame 51 is open in the up-down direction. Four sides of the chart C are supported by the elastic member 52 from the surroundings.

The elastic member 52 is formed of a sponge or the like and can expand and shrink in the up-down direction while abutting against the document table 2. While abutting the document table 2, the elastic member 52 shrinks such that the chart C can be pressed against and adhere to the document table 2. The chart C can be mounted on the document table 2 in an interposed state where one surface adheres to the document M on the upper side and the other surface adheres to the document table 2 on the lower side.

The chart C is at a position where a distance from the sensor 40 can be considered to be the same as a distance from the document M. That is, the control unit 60 can execute the process assuming that the chart C is the document M.

A document cover (not illustrated) may be provided above the image reading apparatus 1. The document cover can adhere the chart C to the document table 2 by pressing the chart C supported by the chart support tool 50 against the document table 2 while compressing the elastic member 52.

It is preferable that a substrate of the chart C is a transparent and thin film or the like through which detection light of the sensor 40 can transmit. As illustrated in FIG. 8, a lattice-shaped pattern that is a predetermined pattern having a high contrast is printed on the chart C. It is preferable that the lattice-shaped pattern is printed using black ink or the like that easily absorbs the detection light of the sensor 40.

In the position specifying operation, the control unit 60 can accurately calculate the focusing evaluation value F by causing the first scanning unit 10 to move the carriage 3 in the first direction X1 and causing the sensor 40 to read the image of the chart C disposed to overlap the document M.

This way, even for the document M having a low contrast, by using the chart C supported by the chart support tool 50, the control unit 60 can accurately calculate the focusing evaluation value F. The control unit 60 can accurately specify the focusing position Hp corresponding to the focusing value Fp.

As described above, by moving the sensor 40 to the specified focusing position Hp, the control unit 60 can also read the document M having a low contrast at the focusing position Hp where the sensor 40 is most focused on the document M to acquire a high-quality image.

As in FIGS. 1, 7, illustrates an example of the image reading apparatus 1 including the second scanning unit 20. Even in the image reading apparatus 1a including the third scanning unit 30 illustrated in FIG. 6, the same operation as that of the above-described image reading apparatus 1 can be executed using the chart C supported by the chart support tool 50.

That is, even for the document M having a low contrast, the image reading apparatus 1a can accurately calculate the focusing evaluation value F using the third scanning unit 30 and the chart C supported by the chart support tool 50.

Incidentally, in the above description with reference to FIGS. 1 to 3, in the position specifying operation, after causing the second scanning unit 20 to move the carriage 3 in the second direction Z1, the image reading apparatus 1 causes the sensor 40 to read the document M while causing the first scanning unit 10 to move the carriage 3 in the first direction X1. The control unit 60 calculates the focusing value Fp where the focusing evaluation value F is the maximum value based on the read pixel value to specify the focusing position Hp corresponding to the calculated focusing value Fp.

For the document M having a high contrast, the sensor 40 can more accurately acquire the pixel value, and the control unit 60 can more accurately calculate the focusing evaluation value F.

Therefore, in the position specifying operation, the image reading apparatus 1 can cause the sensor 40 to read the document M while causing the second scanning unit 20 to directly move the carriage 3 in the position specifying direction.

That is, in this case, in the position specifying operation, the image reading apparatus 1 does not need to cause the sensor 40 to read the document M while causing the first scanning unit 10 to move the carriage 3.

For the document M having a high contrast, the control unit 60 can accurately calculate the focusing evaluation value F by causing the sensor 40 to read the document M while causing the second scanning unit 20 to directly move the carriage 3 in the position specifying direction.

The control unit 60 can calculate the focusing value Fp where the focusing evaluation value F is the maximum value and the focusing position Hp corresponding to the focusing value Fp without causing the first scanning unit 10 to execute scanning. The control unit 60 can cause the second scanning unit 20 to move the carriage 3 to the focusing position Hp to cause the sensor 40 to read the document M.

This way, the image reading apparatus 1 can cause the second scanning unit 20 to move by a distance of the sensor 40 to the document M to specify the focusing position Hp. The image reading apparatus 1 can execute a so-called autofocus operation of automatically focusing the sensor 40. Even when the chart C supported by the chart support tool 50 is used as described above, the image reading apparatus 1 can execute the autofocus operation assuming that the document M has a high contrast.

In addition, even in the image reading apparatus 1a including the third scanning unit 30 illustrated in FIG. 6, the third scanning unit 30 can execute the autofocus operation as in the image reading apparatus 1 in the position specifying operation.

The image reading apparatus 1 according to the above-described embodiment includes the carriage 3 on which the CIS type sensor 40 is mounted, the first scanning unit 10 that moves the carriage 3 in the first direction X1, the second scanning unit 20 that moves the carriage 3 in the second direction Z1 perpendicular to the first direction X1, and the document table 2 that is supported by the document M at the position facing the sensor 40.

The image reading apparatus 1a according to the other example includes the carriage 3 on which the CIS type sensor 40 is mounted, the first scanning unit 10 that moves the carriage 3 along the first guide rail 11 in the first direction X1, the third scanning unit 30 that moves the first guide rail 11 along the third guide rail 31 in the second direction Z1 perpendicular to the first direction X1, and the document table 2 that is supported by the document M at the position facing the sensor 40.

In addition, the control method of the image reading apparatus 1 having the above-described configuration includes: causing the second scanning unit 20 to move the carriage 3 in the second direction Z1 by the predetermined distance; and causing the sensor 40 to read the document M while causing the first scanning unit 10 to move the carriage 3 in the first direction X1. Further, the control method of the image reading apparatus 1 includes: calculating the focusing evaluation value F; calculating a focusing value Fp that is a maximum value of the focusing evaluation value F to specify a focusing position Hp in the second direction Z1 corresponding to the focusing value Fp; and causing the second scanning unit 20 to move the carriage 3 to the focusing position Hp in the second direction Z1.

It is difficult to focus the CIS type sensor 40 because the focal length is shorter than the CCD type sensor. The image reading apparatus 1, the image reading apparatus 1a, and the control method of the image reading apparatus 1 described above can easily specify the focusing position Hp corresponding to the focal length to be accurately focused using the first scanning unit 10 and the second scanning unit 20.

The image reading apparatus 1 can execute reading at the position where the sensor 40 is focused on the document M to acquire a high-quality image.

As described above, the embodiments are described with reference to the drawings, a specific configuration is not limited to the embodiment, and may be changed, replaced, deleted, or the like without departing from the gist of the present disclosure.

The image reading apparatus 1 or 1a may be an image forming apparatus including an ink jet type head.

What is claimed is:

1. An image reading apparatus comprising:
a carriage on which a CIS type sensor is mounted;
a first scanning unit configured to move the carriage in a first direction;
a second scanning unit configured to move the carriage in a second direction perpendicular to the first direction; and
a support unit configured to support a medium at a position facing the sensor.

2. The image reading apparatus according to claim 1, further comprising:
a control unit, wherein
the control unit
causes the second scanning unit to move the carriage in the second direction by a predetermined distance,
calculates a focusing evaluation value by causing the sensor to read the medium while causing the first scanning unit to move the carriage in the first direction,
calculates a focusing value that is a maximum value of the focusing evaluation value to specify a focusing position in the second direction corresponding to the focusing value, and
causes the second scanning unit to move the carriage to the focusing position in the second direction.

3. The image reading apparatus according to claim 2, wherein
a distance sensor is mounted on the sensor, and
the control unit calculates a position of the sensor in the second direction based on a detection value of the distance sensor.

4. The image reading apparatus according to claim 2, wherein
the control unit
causes the sensor to read a first region on one side of the medium and a second region on another side of the medium in the first direction at symmetric positions, and
when it is determined that the calculated focusing evaluation values are close to each other at the symmetric positions, causes the sensor to read one of the first region and the second region and to skip reading another region of the first region and the second region.

5. The image reading apparatus according to claim 2, further comprising:
a chart support tool configured to support a chart on which a predetermined pattern is printed and including a frame that surrounds the chart and an elastic member that is attached to the frame, wherein
the chart supported by the chart support tool is mounted on the support unit in an interposed state where one surface adheres to the medium and another surface adheres to the support unit, and
the control unit calculates the focusing evaluation value by causing the sensor to read the chart overlapping the medium while causing the first scanning unit to move the carriage in the first direction.

6. The image reading apparatus according to claim 1, further comprising:
a control unit, wherein
the control unit
calculates a focusing evaluation value by causing the sensor to read the medium while causing the second scanning unit to move the carriage in the second direction,
calculates a focusing value that is a maximum value of the focusing evaluation value to specify a focusing position in the second direction corresponding to the focusing value, and
causes the second scanning unit to move the carriage to the focusing position in the second direction.

7. An image reading apparatus comprising:
a carriage on which a CIS type sensor is mounted;
a first scanning unit configured to move the carriage along a first scanning shaft in a first direction;
a third scanning unit configured to move the first scanning shaft along a third scanning shaft in a second direction perpendicular to the first direction; and
a support unit configured to support a medium at a position facing the sensor.

8. A control method of an image reading apparatus including
a carriage on which a CIS type sensor is mounted,
a first scanning unit configured to move the carriage in a first direction,
a second scanning unit configured to move the carriage in a second direction perpendicular to the first direction, and
a support unit configured to support a medium at a position facing the sensor,
the control method comprising:
causing the second scanning unit to move the carriage in the second direction by a predetermined distance;
calculating a focusing evaluation value by causing the sensor to read the medium while causing the first scanning unit to move the carriage in the first direction;
calculating a focusing value that is a maximum value of the focusing evaluation value to specify a focusing position in the second direction corresponding to the focusing value, and
causing the second scanning unit to move the carriage to the focusing position in the second direction.
